(19) United States
(12) Patent Application Publication
(10) Pub. No.: US 2015/0264853 A1
(43) Pub. Date: Sep. 24, 2015

(54) Hand-Held Powered Shovel

(71) Applicants: Alex Anthony, Saugus, CA (US); William E. Bryant, Burbank, CA (US)

(72) Inventors: Alex Anthony, Saugus, CA (US); William E. Bryant, Burbank, CA (US)

(21) Appl. No.: 14/223,150

(22) Filed: Mar. 24, 2014

(51) Int. Cl. A01B 1/02

(52) U.S. Cl. CPC A01B 1/02

(57) ABSTRACT

A hand-held powered shovel (10) that is comprised of a handle (12) having a rear end (14), a front end (16) and an outer surface (18). A motor enclosure (22) is attached on the handle (12), and is comprised of a first section (24) and a second section (26). Located within the motor enclosure (22) is a motor (50), which is actuated by a power switch (52) that is located on the handle (12). Extending downward from the handle (12) is a shovel head (40), which is attached to the motor (50). When the power switch (52) is actuated, power from the motor (50) causes the shovel head (40) to move in a reciprocating motion.

### TECHNICAL FIELD

S The invention generally pertains to digging tools, and more particularly to a hand-held powered shovel for use by a single person.

### BACKGROUND ART

Since the days of our earliest ancestors, men and women have utilized tools and other implements to perform various tasks. The types of tools that were utilized depended on the specific task that was being performed. For example, there were tools developed for hunting and cooking, which were two of the most important requirements of our early ancestors. As mankind has progressed the number of tools and the functionality of tools has steadily increased.

There are some tools that have remained fundamentally un-changed in both form and faction. One such tool is a shovel, which has been in use for a long time. A shovel's main function is to dig, although shovels are used for other purposes such as moving a pile of dirt or debris from one location to another.

To accomplish its task a typical shovel is designed as a curved or flat substrate that is attached to a handle. A person holds the handle while using the substrate to dig or carry an item. This is a description of a typical, hand-held manually operated shovel. The extend of a typical shovel's functionality depends on the strength/physical ability of the person using it. For large jobs, such as major construction, shovels have been attached to a vehicle. These types of shovels are powered and capable of digging and/or moving large quantities of dirt or other materials for. extended periods of time.

Unfortunately, as previously stated, a typical hand-held shovel's functionality is reliant on the user's ability. Shoveling, especially heavy material can be a difficult task, and many people, even someone who is strong and fit, are only capable of shoveling for a limited amount of time. What is needed is a hand-held powered shovel that is hand-held. A powered hand-held shovel would allow a person, regardless of their strength, to perform both easy and difficult shoveling jobs, and to do so for extended periods of time.

A search of the prior art did not disclose any literature or patents that read directly on the claims of the instant invention. However, the following U.S. patents are considered related:

| PATENT NO. | INVENTOR | ISSUED |
|---|---|---|
| 3,815,689 | Kuhl | 11 Jun. 1974 |
| 3,975,843 | Ellison | 24 Aug.1976 |
| 5,513,709 | Fisher | 7 May 1996 |

The 3,815,689 patent discloses a highly maneuverable power driven implement for digging holes, such post holes or shrubbery planting holes, or lifting loads. The implement includes a compact chassis having a steerable power-driven rear wheel, a pair of laterally adjustable front wheels projecting ahead of the forward end of the chassis, and a vertical guide at the forward end of the chassis along which a hydraulic auger drive motor is reciprocally movable. A motor driving a variable displacement hydraulic pump selectively supplies power to the hydraulic anger motor, the rear driver wheel motor, and a hydraulic cylinder that reciprocates the auger drive.

The 3,975,843 patent discloses a power spade which is hand operated by one man and does the work of a common pick and shovel. The power spade is designed to operate in confined and restricted areas where larger wheeled or track-conveyor power shovels, ditch diggers, trenches, etc., cannot operate. The invention comprised a portable one-man operated shovel type digger which has an upright frame supporting an endless chain that has a number of buckets attached thereto. A small electric or gasoline motor is coupled to the frame and rives the endless chain on which the buckets are disposed. The buckets have formed sidewalls which are rigidly attached to a chain, and bottoms which are pivotally mounted on the chain, and capable of engaging a cam, thereby ejecting soil contained herein.

The 5,513,709 patent discloses a portable power tool which is lightweight and convenient to use as a wallpaper stripper, a paint scraper or a cold chisel up to a power spade. The tool comprises a housing, a drive, en electric motor adapted to drive at least one selected tool bit mounted on an output shaft moving in a reciprocating axial manner. The drive may be a linear motor or if used with a cam device, a rotary motor.

For background purposes and indicative of the art to which the invention elates, reference may be made to the following remaining patents found in the patent search.

| PATENT NO. | INVENTOR | ISSUED |
|---|---|---|
| 2,890,532 | Ellison | 16 Jun. 1959 |
| 5,147,146 | Harding, Jr. | 15 Sep. 1992 |
| 5,993,109 | Moti et al | 30 Nov. 1999 |
| 7,399,140 | Barcenas | 15 Jul. 2008 |

### DISCLOSURE OF THE INVENTION

In its most basic design, the hand-held powered shovel is comprised of a handle. a motor and a shovel head. The motor is located within a motor enclosure that is attached on the handle. The shovel head extends from the handle and has means for being attached to the motor. A power switch is located on the handle, and when the switch is actuated, the motor applies power to the shovel head. The power causes the shovel head to move up and down in a reciprocating motion.

The shovel head is either permanently attached to the motor, or the shovel head can be removably attached by means selected from the group consisting of a bore and cotton pin, at least one bore and screw, at least one set-screw, at least one nut and bolt, a snap ring, or a threaded screw-on interface. The removably attached shovel head allows a user to selectively attach one of various types of shovel heads that is most appropriate to the shoveling work that is being performed.

The handle is made of metal, wood or plastic. The motor enclosure is preferably made of plastic, and the shovel head is preferably made of metal.

In view of the above disclosure, the primary object of the invention is to provide a hand-held powered shovel that is used by a single person and can significantly reduce the difficulties encountered when using a conventional shovel.

In addition to the primary object of the invention it is also an object of the invention to provide a hand-held powered shovel that:
is easy to use,
can utilize various types of power,
can be utilized by men and women, adults and children,
can be made of lightweight materials,
is durable,
can be disassembled or reduced in size for transportation and storage,
can be made with a variety of styles of shovel heads, for various purposes,
can be used to shovel different materials such as dirt, sand or mud, and
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a front elevational view showing a person holding a hand-held powered shovel.

FIG. 2 is a front elevational view of the hand-held powered shovel.

FIG. 3 is a side elevational view of the hand-held powered shovel.

FIG. 4 is a front elevational view of the hand-held powered shovel as viewed from the shovel head.

FIG. 5 is a rear elevational view of the hand-held powered shovel as viewed from the rear end of the shovel handle.

FIG. 6 is a side elevational view of the hand-held powered shovel's motor enclosure with a motor located therein.

FIG. 7 is a front elevational view of the hand-held powered shovel's shovel head.

FIG. 8 is a front elevational view of a square and serrated digging head shovel head.

FIG. 9 is a front elevational view of a pointed digging head shovel head.

FIG. 10 is a front elevational view of a trenching head shovel head.

FIG. 11 is a front elevational view of a drain spade head shovel head.

FIG. 12 is a front elevational view of a scoop head shovel head.

FIG. 13 is a front elevational view of a scraper head shovel head.

FIG. 14 is a front elevational view of an edger head shovel head.

FIG. 15 is a front elevational view of a hand grip attached to the hand-held powered shovel's handle.

FIG. 16 is a side elevational view showing the handheld powered shovel's handle with a hand-hold and non-slip material.

### BEST MODE FOR CARRYING OUT THE INVENTION

The best mode for carrying out the invention is presented in terms that disclose a preferred embodiment of a hand-held powered shovel. A shovel is one of most effective and widely used implements for digging and transferring substance, such as dirt or snow, from one location to another. Typically, a conventional shovel is a single-person, hand-held implement. Although a shovel is an effective means of accomplishing multiple tasks, the use of a shovel can often require physical strength and endurance, especially for tasks that are performed for extended periods of time. The instant hand-held powered shovel provides a user with an implement that removes much of the difficulty that is experienced when using a conventional shovel.

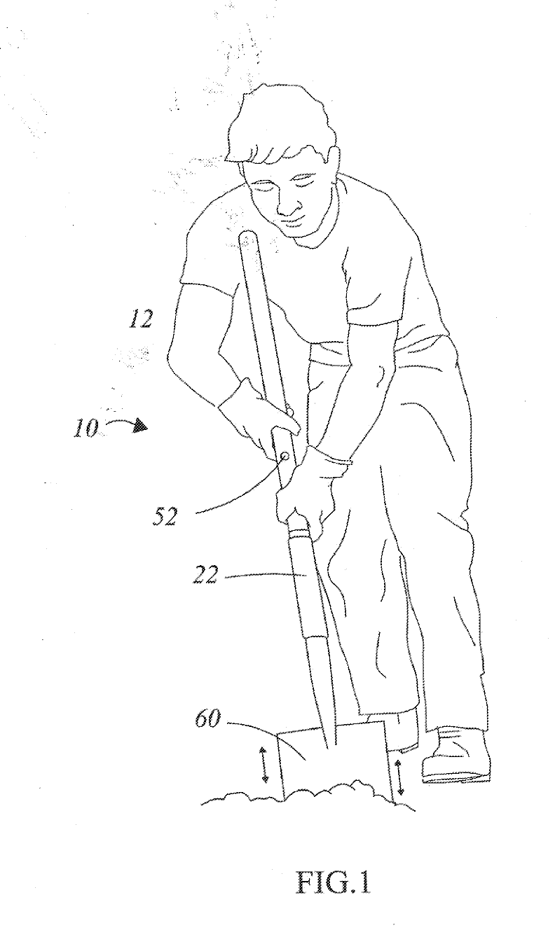

The hand-held shovel 10, as shown in FIGS. 1-16, is comprised of four major elements: a handle 12, a motor enclosure 22, a motor 40 and a shovel head 60. The handle 12, as shown in FIGS. 1-6, has a rear end 14, a front end 16 and an outer surface 18. The handle 12 is made of a material selected from the group consisting of metal, wood, a composite material or plastic. The handle 12 preferably has a circular longitudinal shape, although any geometric shape can be utilized. The length of the handle 12 can range from 10 inches (25.4 cm) to 60 inches (152.4 cm).

The motor enclosure 22, as shown in FIGS. 1-7, is attached on the handle 12 and comprises a first section 24 and a second section 26 that are maintained together by a securing means 28. The motor enclosure 22 is made of a material selected from the group consisting of metal, wood, a composite material or plastic. The securing means 28 for maintaining the motor enclosure's two sections together are selected from the group consisting of at least one screw 30, at least one snap closer 32 or at least one hinged locking device 34. Although the motor enclosure 22 is preferably made of the two sections 24,26 which facilitates easy access to the motor 40 within the motor enclosure can also be made as a one-piece enclosure. Additionally, the motor enclosure 22 can also be made integral to the handle 12.

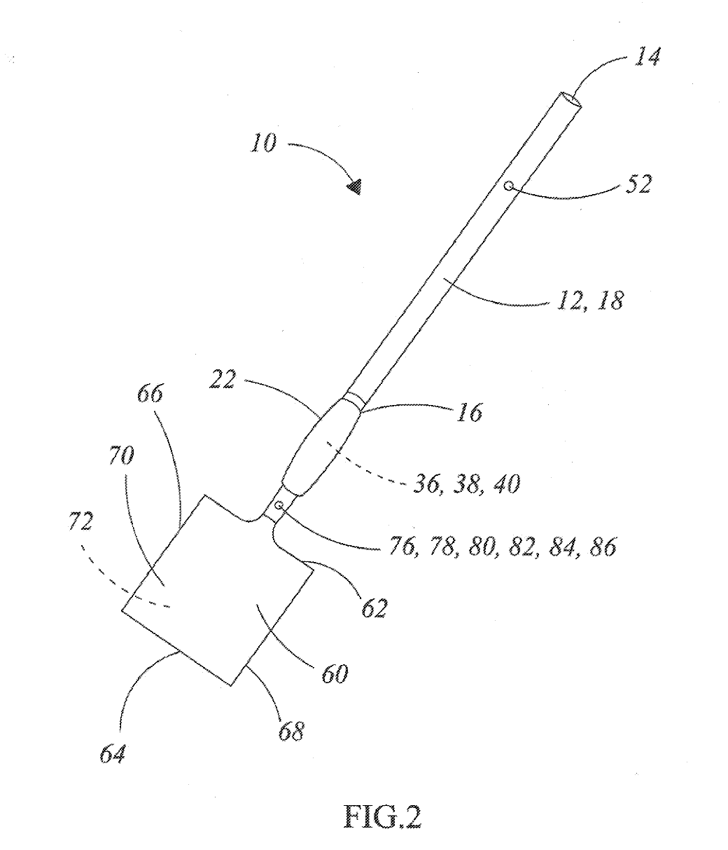

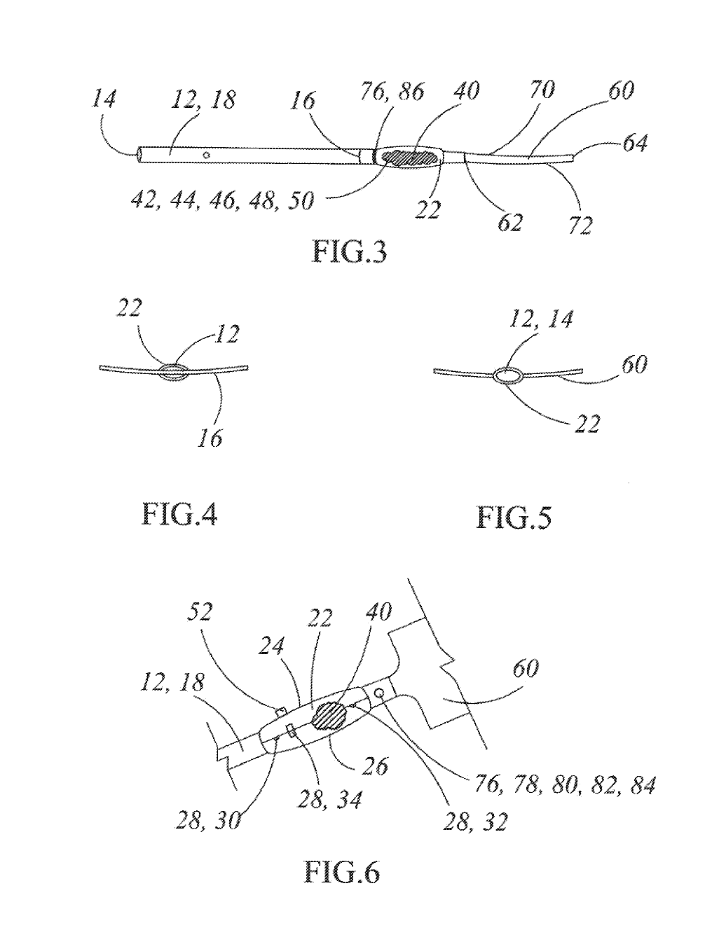

As shown in FIGS. 3 and 6, the motor 40 is located within the motor enclosure 22. The motor 40 is actuated by a power source 42 that is selected from the group consisting of electric utility power 44, battery power 46, gasoline power 48 or pneumatic power 50. When the motor 40 is battery-powered, the battery can be rechargeable. The types of batteries that can be utilized include but are not limited to, an alkaline, a lithium or a nickel-cadmium. The motor's 40 power source 42 is operated by a power switch 52 that is located on the handle 12, as shown. in FIGS. 1 and 2, or on the motor enclosure 22, as shown in FIG. 6.

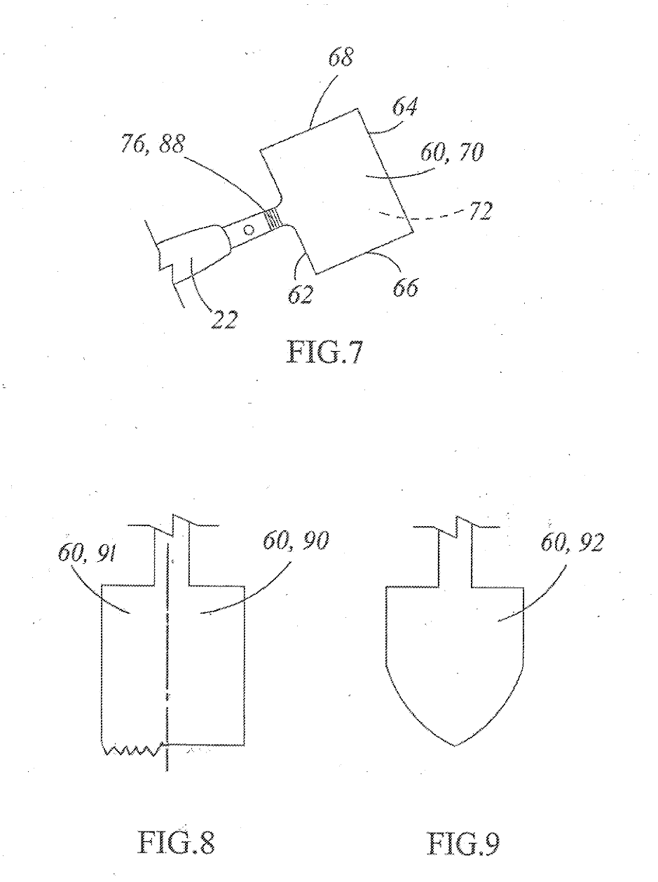

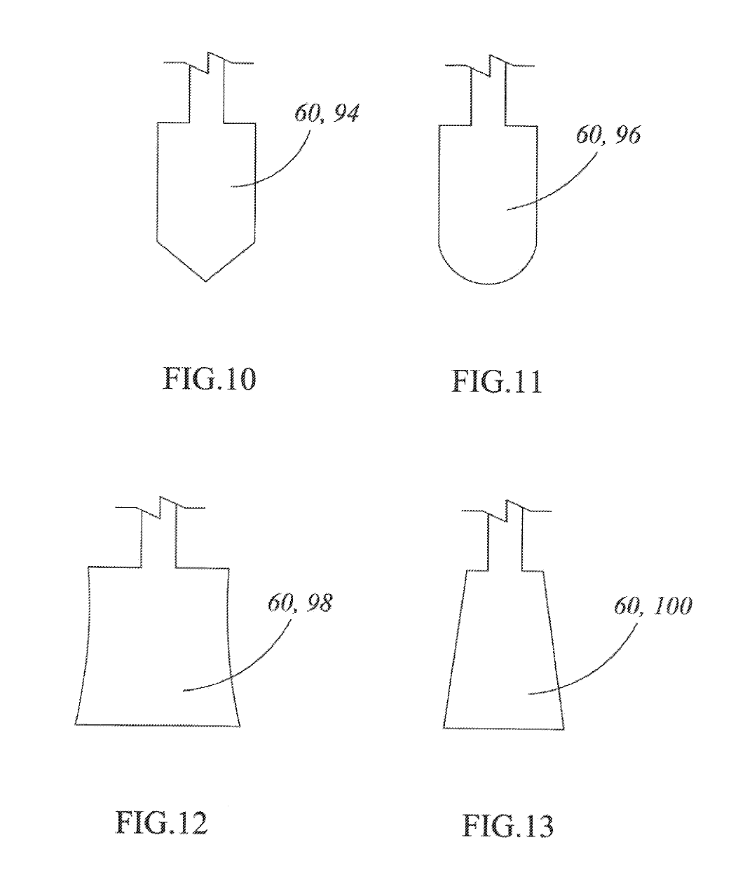

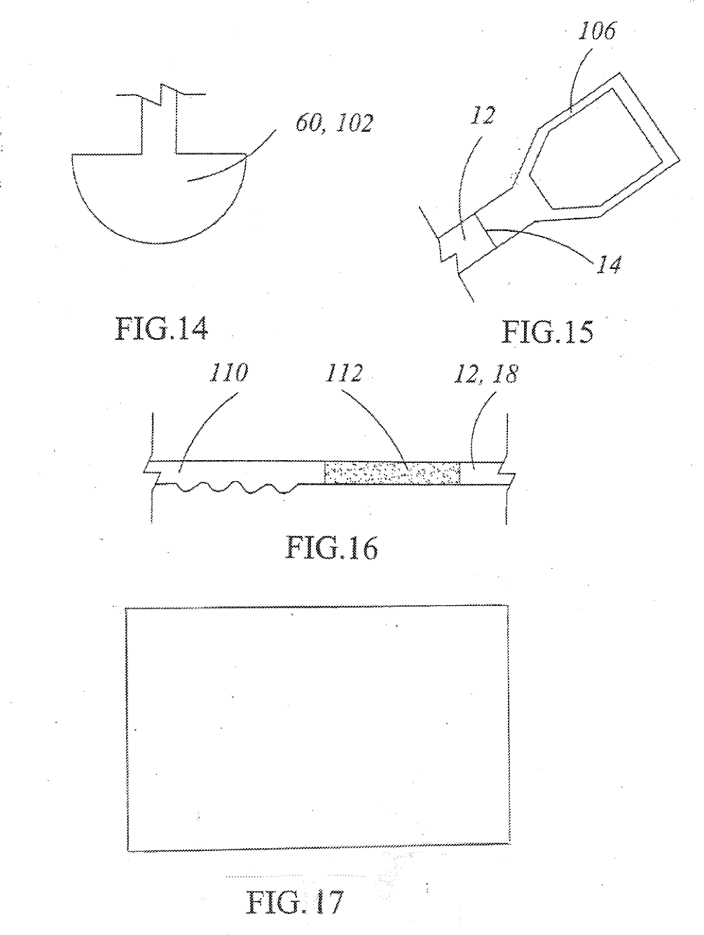

The shovel head 60, as shown in FIGS. 1, 2, 3, 6-14, has an upper edge 62, a lower edge 64, a first side edge 66, a second side edge 68, an upper surface 70 and a lower surface 72. The shovel head 60 is made of a material selected from the group consisting of metal, wood, a composite material or plastic. The shovel head 60 extends downward from the front end 16 of the handle 12 and has an attachment means 76 for being attached to the motor 40. The attachment means 76, as shown in FIG. 6, include at least one bore and cotter pin 78, at least one threaded bore and screw 80, at least one set-screw 82, at least one nut and bolt 84, a snap ring 86, as shown in FIG. 3, or a threaded screw-on interface 88, as shown in FIG. 7. All of the above attachment means 76 allow the shovel head 60 to be removed from the motor 40. This facilitates the use of various types of shovel heads, depending on the requirement(s) of the task that is being performed. Although, a removable shovel head is preferred, the shovel head 60 can be permanently attached to the motor 40. The shovel head's lower edge 64 has a shape that can consist of a digging head that can be square 90, as shown on the right side of FIG. 8 or have a serrated edge 91, as shown on the left side of FIG. 8. The shovel head can also be pointed 92, as shown in FIG. 9; a trenching head 94, as shown in FIG. 10; a drain spade head 96, as shown in FIG. 11; a scoop head 98, as shown in FIG. 12, a scraper head 100, as shown in FIG. 13; or an edger head 102, as shown in FIG. 14, or any other type of head.

When the power switch 52 on the handle 12 or the motor enclosure 22 is actuated, power from the motor 40 causes the shovel head 60 to move in a reciprocating motion. The speed/frequency at which the shovel head reciprocately moves is either a set, single-speed, or can be selectively changed by a user by the use of a control means such as a knob 54, which is also located on the handle 12 or motor enclosure 22.

To add further utility to the hand-held powered shovel 10, a hand grip 106 can extend from the rear end 14 of the handle 12, as shown in FIG. 15.

A hand-hold 110, as shown in FIG. 16, can be either attached onto the outer surface 18 of the handle 12, or can be integrally molded into the handle 12 when the handle 12 is made of compatible material. Additionally, a non-slip material 112 can be attached to the handle 12, as shown in FIG. 16, to facilitate a better grip for a user. The handle 12 can also be designed to telescope or be separated into two or more parts to allow easy transportation and/or storage of the hand-held powered shovel 10.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1.-9. (canceled)

10. A hand-held powered shovel comprising:
a) a shovel head having an upper edge and a lower edge,
b) an elongated handle having a rear end and a front end, wherein the front end is attached to the upper edge of said shovel head,
c) an enclosure attached onto said elongated handle, said enclosure having a first section and a second section that are maintained together by an enclosure securing means selected from the group consisting of at least one screw, at least one snap closer, and at least one hinged locking device, and
d) a power application assembly located within said enclosure, said assembly comprising a reciprocating electric motor that utilizes an alternating magnetic field to move its armature back and forth, wherein said armature is comprised of a permanent magnet which has attached to at least one of its ends a field coil, wherein the field coil exerts both a repulsive and an attractive force that is applied to the armature, causing the motor to produce an output consisting of a linear, reciprocating motion, wherein the output interfaces with the rear end of said elongated handle, wherein when a power switch connected to a power source and located on said elongated handle is actuated, said power application assembly is enabled, causing said shovel head to move in a linear, reciprocating motion.

11.-20. (canceled)
